(19) United States
(12) Patent Application Publication
(10) Pub. No.: US 2012/0227312 A1
(43) Pub. Date: Sep. 13, 2012

(54) ARTHROPOD TRAP HAVING INTEGRATED FLUID ATTRACTANT DISPENSER

(75) Inventors: Joseph R. FAIRLEIGH, Boca Raton, FL (US); Jonathan A. GLOBERSON, Sunny Isles Beach, FL (US); Jeffrey Scott DiBARTOLO, Lighthouse Point, FL (US)

(73) Assignee: GREEN HOME SHIELD, LLLP, Deerfield Beach, FL (US)

(21) Appl. No.: 13/042,897

(22) Filed: Mar. 8, 2011

(51) Int. Cl. A01M 99/00; A01M 1/10; A01M 23/00

(52) U.S. Cl. 43/58

(57) ABSTRACT

A method and system for trapping arthropods includes a base and a first wall coupled to the base. The base and the first wall define a fluid source retention area. The first wall has an exterior surface. The device also includes a second wall coupled to the base and surrounds the first wall. The second wall has an interior and exterior surface. The exterior surface of the second wall has a first texture, and the exterior surface of the first wall and interior surface of the second wall have a second texture. The first texture is more coarse than the second texture.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a method and system for trapping arthropods.

### BACKGROUND OF THE INVENTION

Arthropods are invertebrate animals including insects, arachnids and others creatures. Notably, the arthropod classification also includes a notorious household pest; bed bugs. This pest has been around for centuries and is one of the most widely recognized insects in the world. Even though bed bugs were thought to have all but disappeared in western countries due to the use of pesticides, they have reappeared in the United States. There are contributing factors to this growing bed bug epidemic such as increased travel to and from bed bug infested countries and increased resistance to insecticides. For example, arthropods have been shown to have developed resistance to currently available insecticides. Regardless of the reason, a solution is needed to help stop and reverse the bed bug outbreak.

The use of pesticides to exterminate bed bugs is no longer commonly used due to the toxic nature of the chemicals. Specifically, most pesticides work by poisoning the bed bug, which in turn might end up poisoning a human. As such, industry professionals started using insecticides to control the bed bugs population. However, the effectiveness of insecticides is limited because they are not as toxic as pesticides. Even the use of stronger, more effective insecticides in a home or business is not desired due to the health effects of coming into contact with such chemicals. As such, buildings owners are wary of using any insecticides, let alone pesticides, to treat a bed bug infested site.

Moreover, using insecticides can have a disastrous effect on the treated site. For example, furniture or carpet being treated is highly susceptible to discoloring and even damage due to the chemicals in the insecticide. The fumes from insecticides are unappealing. Further, few people want their children playing in an area that may contain insecticide residue due to the fear that even non-toxic insecticides may have hidden long term side effects. Accordingly, the use of insecticides is often a last resort due to their significant disadvantages.

In order to overcome this problem, non-insecticide approaches are being used. Such approaches vary from steam cleaning the arthropod inhabited area to wrapping the area in a specialized material. While these approaches may have some success, they are time consuming, costly and aesthetically unappealing. For instance, hiring professional steam cleaners is costly. Also, once steam cleaned, there is no way to know if the bed bugs will return to the area since they may also live in places that were not steam cleaned, such as hidden cracks in the walls. Also, individually wrapping every piece of furniture in a home with specially designed covers is costly and is likely to look unpleasant. As such, these approaches are unlikely to be used.

Moreover, a common misconception exists that beg bugs only live in furniture, e.g., a bed; however, beg bugs may also live in other parts of a building. For example, beg bugs may also live in the narrow cracks of a wall and/or floor of a building, sometimes traveling up to 20 feet from these hiding places to find a host to feed on. In other words, beg bugs may infest the parts of the building that are harder or near impossible to treat using the non-insecticide approaches discussed above. Accordingly, these approaches may be of little practical use in capturing arthropods living in a wall and/or floor crack.

Also, none of these approaches take advantage of the bed bugs' own senses to lure them into a trap, thereby increasing the trap's effectiveness. A bed bug's necessity to feed on blood has led them to develop keen senses, allowing them to find a suitable host, e.g., mammals such as humans and house pets, to feed on. For example, bed bugs have been found to be attracted to carbon dioxide, circulating blood and host kairomones, e.g., dried human sweat. In some situations, bed bugs have been able to locate a host almost 5 feet away, likely based in part on their senses. Nevertheless, these approaches fail to utilize a bed bug's own senses against it to trap and/or kill it.

Consequently, there is a need for an arthropod trapping method and system to efficiently and effectively capture arthropods, such as bed bugs, without the use of pesticides, insecticides and/or costly equipment. There is also a need for an arthropod trapping method and system that allows for arthropod trapping in a wide variety of areas in a building ranging from isolated areas with no furniture to common areas with furniture.

### SUMMARY OF THE INVENTION

The present invention advantageously provides a method and system for trapping arthropods. In accordance with one aspect, the invention provides a device for trapping arthropods having a base and a first wall coupled to the base. The base and the first wall define a fluid source retention area. The first wall has an exterior surface. The device also includes a second wall coupled to the base and surrounds the first wall. The second wall has an interior and exterior surface. The exterior surface of the second wall has a first texture, and the exterior surface of the first wall and interior surface of the second wall have a second texture. The first texture is more coarse than the second texture.

In accordance with another aspect, the invention provides a system for trapping arthropods includes a capture platform and a fluid source. The capture platform has a base and an outer wall coupled to the base. The outer wall has an interior surface, an exterior surface and a perimeter. The exterior surface of the outer wall has a first texture and the interior surface of the outer wall has a second texture in which the first texture is more course than the second texture. The capture platform also includes a fluid source retention area.

In accordance with yet another aspect, the invention provides a method for trapping arthropods. A trap that having a base is positioned. The base includes a first wall coupled to the base. The base and the first wall define a fluid source retention area. The first wall has an exterior surface. The base also includes a second wall coupled to the base and surrounding the first wall. The second wall has an interior and exterior surface. The exterior surface of the second wall has a first texture. The exterior surface of the first wall and interior surface of the second wall have a second texture. The first texture is more coarse than the second texture.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an exemplary arthropod trapping system constructed in according with the present invention;

FIG. 2 is a top view of the exemplary arthropod trapping system of FIG. 1; and

FIG. 3 is a cross-section view taken through section A-A of FIG. 2.

### DETAILED DESCRIPTION OF THE INVENTION

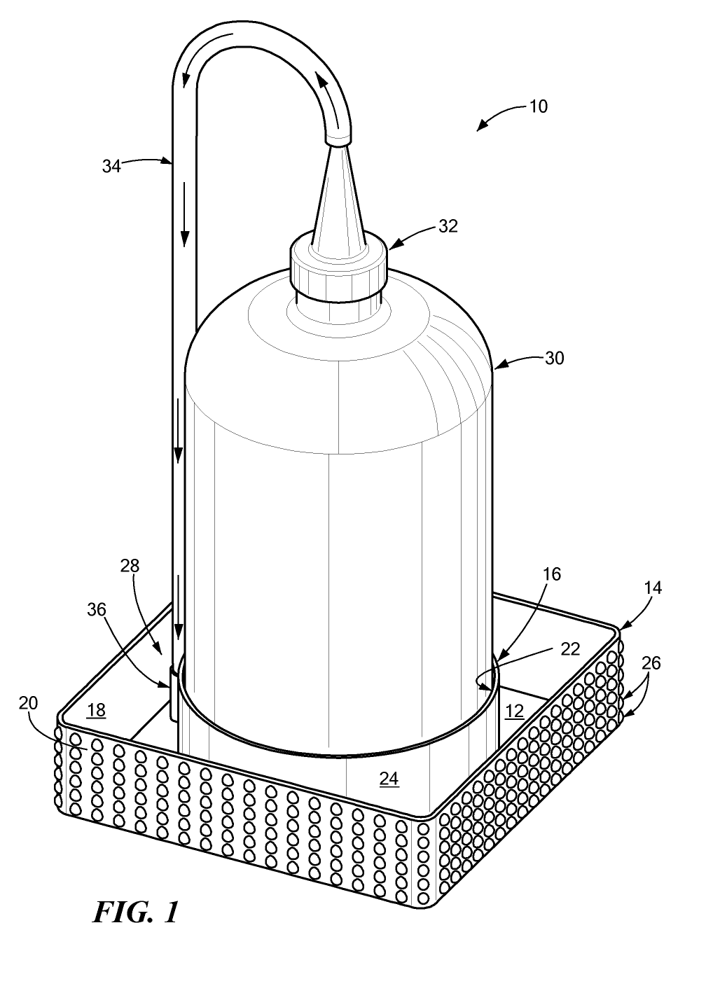

The present invention provides a standalone arthropod trapping system incorporating direct fluid injection that attracts arthropods into a trapping channel. Referring now to the drawing figures, in which like reference designators refer to like element, there is shown in FIG. 1 a system constructed in accordance with the principles of the present invention and designated generally as “10.” System 10 includes a base 12, an outer wall 14 and inner wall 16 defining a capture platform. Both walls are coupled to the base 12. The outer wall 14 may have an interior surface 18, exterior surface 20 and perimeter. The inner wall 16 may have an interior surface 22, exterior surface 24 and perimeter. The inner wall 16 is disposed within the perimeter of the outer wall 14. Each of the wall surfaces may have a respective texture, e.g., coarse texture having bumps 26.

System 10 may also include a channel 28 defined by the outer wall 14, inner wall 16 and the base 12. System 10 may also include a container 30, i.e., a fluid source, disposed within the perimeter of the inner wall 16. The container 30 may hold fluid and/or other materials and/or may dispense the fluid. As used herein the term “fluid” is used in the traditional sense and refers to a liquid, gas or combination thereof. The container 30 may include a detachably coupled nozzle 32 that may allow access to the interior of the container 30. System 10 may also include a fluid conduit 34 detachably coupled to the container 30 and/or the conduit coupling 36. The fluid conduit 34 may provide a fluid path from the container 30 to the channel 28. A conduit coupling 36 may be disposed within the channel 28 and is arranged to receive and emit the fluid from the container 30.

In particular, with reference to FIG. 1, the base 12 may be a foundation upon which the trapping structure is built. For example, the base 12 may be a platform, substantially planar surface and the like that may be made of a polymer, metal and the like. The base 12 may be manufactured as one piece or as several pieces that may be assembled. Moreover, the shape of the base 12 may be geometric, non-geometric or a combination thereof.

The outer wall 14 is coupled to and is substantially perpendicular to the base 12. The outer wall 14 has a height, width, thickness, perimeter, interior surface 18 and exterior surface 20. Also, the outer wall 14 may be located proximate the edge of the base 12 so as to substantially conform to the shape of the base 12. For example, the outer wall 14 may substantially conform to the quadrangular shape of the base 12. Moreover, the perimeter of the outer wall 14 may be geometric, non-geometric or combination thereof The outer wall 14 may have a tapered upper portion (not shown) that may produce a narrow peak that may facilitate arthropods falling over the outer wall 14, i.e., fall within the perimeter of the outer wall 14. The tapered upper portion of the outer wall 14 may be sloped, flat, multi-sided, inwardly sloped, non-symmetric and the like. The outer wall 14 may be composed of material that is substantially the same or different from the material used for the base 12.

The interior surface 18 of the outer wall 14 may substantially face the inner wall 16 and may have a smooth texture. In particular, a smooth texture, as used herein, describes a surface with a texture that prevents arthropods from effectively climbing the surface. For example, the smooth texture may be a surface having minimal coarseness or coarseness so fine that the texture may appear and feel substantially smooth. The exterior surface 20 of the outer wall 14 may face in substantially the opposite direction as the interior surface 18 of the outer wall 14. The exterior surface 20 of the outer wall 14 may include a surface having a coarse texture. In particular, a coarse texture, as used herein, describes a surface with a texture that allows arthropods to climb the surface. In other words, the exterior surface 20 of the outer wall 14 may be more coarse than the interior surface 18 of the outer wall 14. While the coarse texture is illustrated in FIG. 1 as a uniform series of bumps 26, the coarse texture may also be a uniform and/or non-uniform series of geometric and/or non-geometric shapes including bumps, indents, notches and the like. Also, one of ordinary skill in the art will understand that a smooth and/or coarse surface may come from the properties of the material being used and/or may be created by the use of machining, coatings and the like.

Moreover, the texture of the wall surfaces may be quantified by surface roughness (Ra). In particular, surface roughness is the arithmetic average deviation of the surface valleys and peaks, expressed in microns that indicate a measure of the surface texture. For example, the smooth texture may correspond to a surface roughness range or value (Raₛₘₒₒₜₕ) capable of preventing arthropods from climbing the surface, e.g., the interior surface 18 of the outer wall 14 may have a surface roughness value of Raₛₘₒₒₜₕ. Also, the coarse texture may correspond to a surface roughness range or value (Ra_{coarse}) capable of allowing arthropods to climb the surface, e.g., the exterior surface 20 of the outer wall 14 may have a surface roughness value of Ra_{coarse}. All other surfaces in system 10 may have a Ra value based on their respective function. By way of non-limiting example, the smooth texture can have a Ra value ranging from about 0.1 micrometers (μm) to 3.0 μm, and the coarse texture can have a Ra value ranging from about 4.0 μm and up. Also, each smooth texture and each coarse texture need not have the exact same respective Ra value.

The system 10 may also include an inner wall 16 coupled to the base 12. The inner wall 16 may be disposed within the perimeter of the outer wall 14. The inner wall 16 has a height, width, thickness, perimeter, interior surface 22 and exterior surface 24. The height, width, thickness and perimeter of the inner wall 16 may be varied depending on a variety of factors such as cost, size of arthropods, manufacturing, and the like. In particular, the height, width and thickness of the inner wall 16 may be substantially the same or different from the height, width and thickness of the outer wall 14. Also, the inner wall 16 may be composed of material that is substantially the same or different from the material used for the base 12 and/or outer wall 14. The exterior surface 24 of the inner wall 16 may have the smooth texture and the interior surface 22 of the inner wall 16 may have a smooth or coarse texture as is discussed below.

System 10 may have a channel 28 defined by the interior surface 18 of the outer wall 14, exterior surface 24 of the inner wall 16 and the base 12, each serving as a different side of the channel 28, with the remaining side being open to the environment. In other words, the channel 28 may be defined by the area between the base 12, the outer wall 14 and the inner wall 16. The channel 28 traps arthropods that have fallen within. For example, the coarse texture of the exterior surface 20 of the outer wall 14 may allow arthropods to climb the surface and fall into the channel 28. Once within the channel 28, the smooth textured surfaces of the interior surface 18 of the outer wall 14 and the exterior surface 24 of the inner wall 16 prevent the arthropods from climbing out of the channel 28. As such, the coarse/smooth texture configuration of the wall surfaces in system 10 allows arthropods to climb specific surface(s) while being unable to climb other surfaces.

The container 30 has an aperture (not shown) to allow access to the interior volume of the container 30. The container 30 may hold fluid and/or other materials and/or dispense fluid. The container 30 may be composed of plastic, glass, metal and/or any other material suitable for holding fluid and/or other materials and/or dispensing fluid. The shape of the lower portion of the container 30 may substantially conform to the perimeter of the inner wall 16 or may be a different shape. Also, a nozzle 32 may be removably coupled to the container 30 to allow placement of the fluid and/or other materials inside the container 30. For example, a user may remove the nozzle 32 and fill the container 30 with water and drop tablets, powders or other ingredients into the water to produce carbon dioxide.

The container 30 may also include a fluid regulator (not shown) to control the flow of fluid from the container 30. For example, the fluid regulator may simply be the dimensions of the container 30 and/or nozzle 32 that may cause the fluid to dispense at a certain rate from the container 30, e.g., cause the fluid to dispense slowly. Also, additional components may be used to control the fluid flow from the container 30 such as a nozzle with an adjustable opening. Other types of fluid regulators may be used.

Also, the system 10 may include a fluid conduit 34 having a distal end and proximal end opposite the distal end. The proximal end of the fluid conduit 34 may be removably coupled to the nozzle 32 and the distal end may be coupled to the conduit coupling 36. In particular, the fluid conduit 34 provides a fluid path from the container 30 to the channel 28 via the conduit coupling 36. For example, the fluid conduit 34 may serve as a path for carbon dioxide to travel, eventually being dispensed in the channel 28.

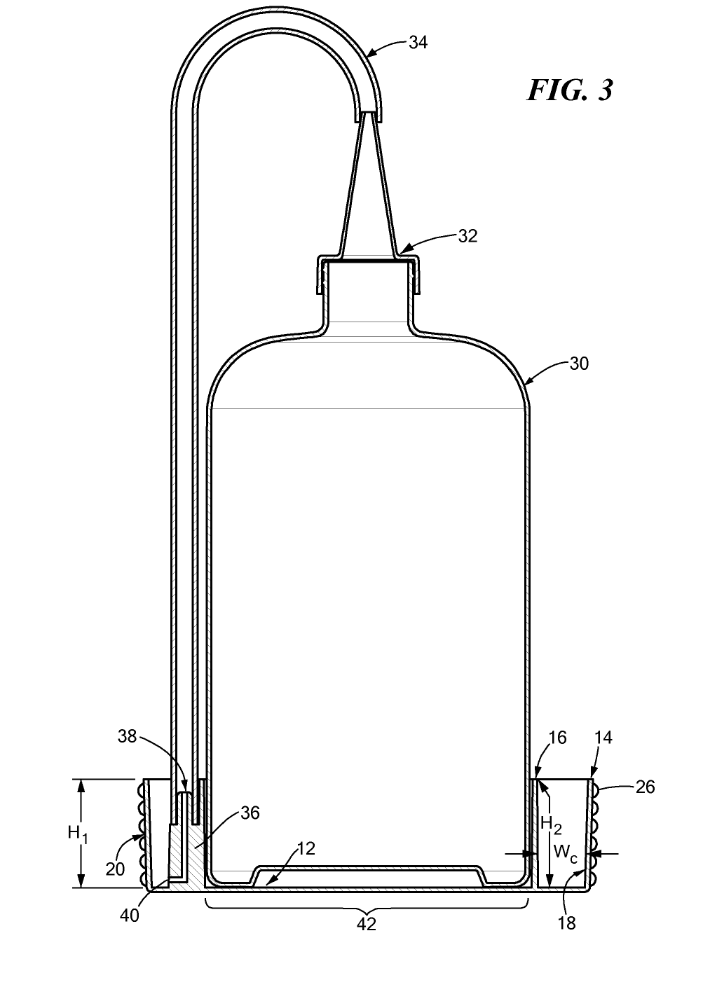

The conduit coupling 36 is disposed within the channel 28. The conduit coupling 36 may be coupled to the base 12 and/or inner wall 16 and/or another portion of the system 10. Specifically, the conduit coupling 36 may direct fluid from the fluid conduit 34 toward the channel 28. Once dispensed from the conduit coupling 36, the fluid may diffuse onto the entire device and subsequently into the surrounding area. However, the concentration of fluid remains strongest within the channel 28, i.e., remains strongest at the source. For example, arthropods may seek out the strongest concentration of fluid, likely believing the source to be a host to feed on, only to end up trapped within the channel 28. The conduit coupling 36 is discussed below with reference to FIG. 3.

The specific type or mixture of fluid used may be based on factors such as the fluid's arthropod attractant properties, ease of use, cost, duration, non-toxic properties and the like. For example, carbon dioxide may be used to attract arthropods to the trap because it is a strong attractant of certain arthropods. The use of an attractant may encourage arthropods to leave their nesting place(s) such as inside a piece of furniture and/or inside a crack in the wall and travel to the trapping system 10. Also, carbon dioxide can be produced for a substantial period of time by using water soluble carbon dioxide tablets or powders, e.g., carbon dioxide can be produced from the tablets for approximately 4-5 days, thereby allowing greater time between refills. Also, the carbon dioxide mixture within the container 30 may indicate that no more carbon dioxide is being emitted because the water will turn substantially clear and bubbles will not form when the container 30 is shaken, thereby alerting the user to refill the container 30. Once the carbon dioxide mixture is depleted, any leftover contents in the container 30 may be rinsed and poured down the sink without fear of harming the environment, i.e., the leftover contents in the container 30 are non-toxic and non-corrosive. Also, carbon dioxide does not leave residue on furniture, thereby simplify clean up.

Moreover, using tablets or powders to create carbon dioxide is inexpensive, a feature that enables lower income families to run and re-run the system 10 as many times as needed. Also, carbon dioxide in the quantities released by the trap is non-threatening to consumers as it is commonly found in our environment, e.g., humans release carbon dioxide when breathing. Nevertheless, one of ordinary skill in the art will recognize that other types of fluids and mixtures of fluids and/or solids may be used to produce a fluid meeting some or all of the factors discussed above with respect to carbon dioxide.

Additionally, Diatomaceous Earth may be disposed, e.g., sprayed, scattered, sprinkled and the like, onto the trap to incapacitate any arthropods that venture into the trap. In particular, Diatomaceous Earth may be sprayed onto the entire trap or a portion of the trap. For example, Diatomaceous Earth may be sprayed onto the channel 28 to incapacitate arthropods that have fallen therein. Specifically, Diatomaceous Earth is a silica dioxide powder that may incapacitate arthropods mechanically, as opposed to chemically (e.g., pesticides). For example, the Diatomaceous Earth may act similar to broken glass when an insect ingest or crawls on top of it, thereby incapacitating the arthropod mechanically. Also, Diatomaceous Earth may make surfaces more difficult to climb when added to the trap, e.g., Diatomaceous Earth may make surfaces more smooth/slippery or less coarse. Different concentrations of Diatomaceous Earth may be disposed onto the trap depending on a number of factors such as user preference, availability and the like. For example, Diatomaceous Earth containing less than 3% silica dioxide may be used. As such, Diatomaceous Earth may be added to the arthropod trap to lessen the chance of an arthropod escaping and/or to kill the arthropod.

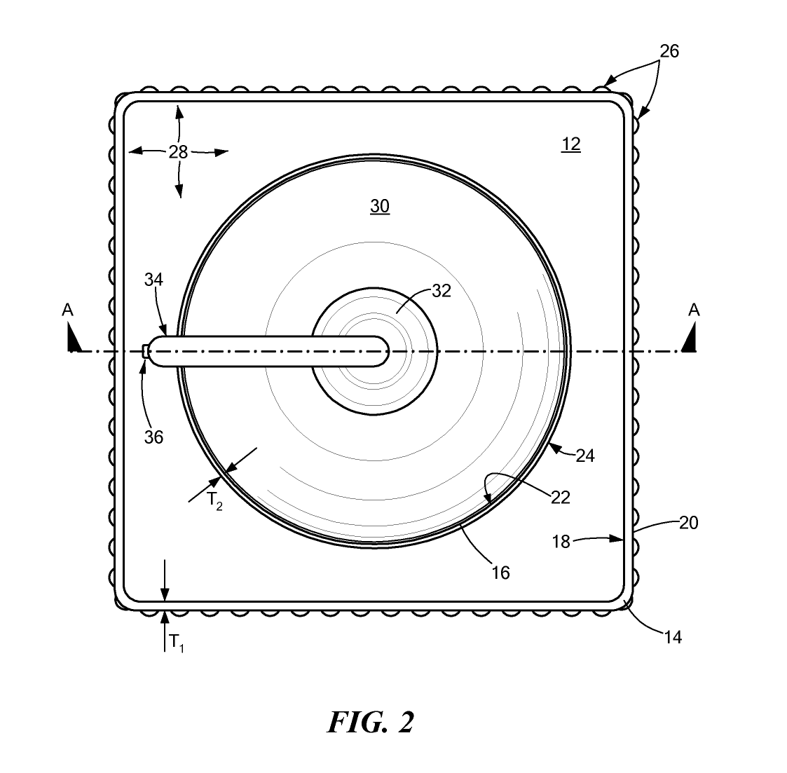

FIG. 2 illustrates a top view of the system 10 illustrated in FIG. 1. The thicknesses of the walls are denoted as T1 and T2. Specifically, the thickness of the outer wall 14 is indicated as T1 and may be substantially constant throughout. Also, the thickness of the inner wall 16 is indicated as T2 and may also be substantially constant throughout. The thicknesses T1 and T2 may be substantially equal or different from each other, e.g., T1 is greater than T2 or T2 is greater than T1. Moreover, the thicknesses T1 and/or T2 may be varied, e.g., tapered.

Also, the width of the channel 28 may vary as illustrated in FIG. 2. For example, as illustrated in FIG. 2, the width of the channel 28 is greatest at the corners of the system 10. Alternatively, the width of the channel 28 may remain substantially constant by modifying the shape of the inner wall 16 and/or outer wall 14. In other words, the width of the channel 28 may be configured to accommodate different size arthropods, reduce the overall footprint of the trap and the like.

FIG. 3 is a view taken through section A-A of FIG. 2. Starting with the outside of the system 10, the outer wall 14 may be substantially perpendicular to the base 12 and may have a height H1. The exterior surface 20 of the outer wall 14 may have the course texture such as a uniform series of bumps 26 that may function to allow arthropods to climb the exterior surface 20 of the outer wall 14. The interior surface 18 of the outer wall 14 may have a smooth texture as compared with the coarse texture and may function to prevent arthropods from climbing the interior surface 18 of the outer wall 14.

The inner wall 16 may be substantially perpendicular to the base 12 and/or substantially parallel to the outer wall 14. The inner wall 16 may have a height H2 and the exterior surface 24 of the inner wall 16 may have the smooth texture that may function to prevent arthropods from climbing the exterior surface 24 of the inner wall 16. Moreover, the outer wall 14 and inner wall 16 may define the channel 28 having a width (Wc) that may be varied depending on the configuration of the walls. Also, the interior surface 22 (see FIG. 2) of the inner wall 16 may have a smooth texture, e.g., no bumps 26. For example, the interior surface 22 (see FIG. 2) of the inner wall 16 may have the smooth texture that may allow for easier removal and/or insertion of the container 30. Alternatively, the interior surface 22 (see FIG. 2) of the inner wall 16 may have the coarse texture that may function to further secure the container 30 to the trap, e.g., may hold the container 30 tighter or add traction. Also, the coarse texture of the interior surface 22 (see FIG. 2) of the inner wall 16 may allow the trap to be reconfigured. For example, the fluid source may be disposed outside the trap and a furniture leg may be placed within the perimeter of the inner wall 16. This reconfiguration of the trap may allow the user to specifically target a piece of furniture. In other words, the interior surface 22 (see FIG. 2) of the inner wall 16 having a coarse texture may allow the user to configure the trap to target a specific nesting area of arthropods.

FIG. 3 also shows the fluid conduit 34 that provides a path from the container 30 to the conduit coupling 36. The fluid conduit 34 may have different shapes, sizes and lengths depending on a variety of factors including cost, space available, manufacturing, fluid flow rate and the like. Also, the nozzle 32 may be removably coupled to the container 30. For example, the nozzle 32 may be screwed, snap fit and like onto the container 30. The nozzle 32 may include different shapes, sizes and lengths depending on a variety of factors including cost, fluid flow rate, size of container 30 and the like, e.g., the nozzle 32 openings may be increased in order to allow a greater fluid flow rate. Furthermore, the width, height and area of the container 30 may be varied based on several factors such as amount of fluid storage, fluid flow rate, cost and the like. As such, the system 10 having an intergraded fluid attractant may be re-sized and modified in accordance with the principles of the invention.

Still referring to FIG. 3, the conduit coupling 36 is illustrated having a first port 38, second port 40 and fluid path connecting the ports. The conduit coupling 36 may be coupled to the base 12, inner wall 16 and/or another portion of the trap. In particular, the first port 38 may receive the fluid from the fluid conduit 34 discussed below. The fluid may then travel through the fluid path and be emitted from the second port 40. The size, number and configuration of the ports and fluid path may be varied depending on various factors such as manufacturing, fluid regulation, fluid dispersion and the like. For example, the second port 40 may be composed of a plurality of ports, each emitting the fluid in the same or a different direction, i.e., may allow the fluid to diffuse onto the trap. Moreover, the first port 38, second port 40 and/or plurality of ports may be adjustable by the user via methods known in the art, e.g., adjustable apertures. Also, the shape, size and configuration of the conduit coupling 36 may vary depending on various factors such as cost, fluid flow rate, manufacturing and the like, e.g., the size may be reduced in order to slow down the fluid flow rate or the size may be increased to accommodate a larger fluid conduit 34. Also, the conduit coupling 36 may be a clip (not shown) that is removably coupled to the fluid conduit 34 and to the inner wall 16, outer wall 14 or another portion of the trap. In other words, the clip may function to secure the fluid conduit 34 in a position proximate to the channel 28.

System 10, specifically the capture platform, may include a fluid source retention area 42 defined by the interior surface 22 of the inner wall 16 and the base 12. In particular, the container 30 may be disposed on base 12 and held substantial in place by inner wall 16. For example, the inner wall 16 and the base 12 are substantially in contact with the container 30, i.e., the fluid source retention area 42 may substantially conform to the shape of the container. As such, the fluid source retention area 42 secures the container 30 in place, e.g., secures the fluid source or container 30 in place while the trap is deployed to help prevent the container from tipping over.

Alternatively, the fluid source retention area 42 may be shaped substantially differently from the container 30. For example, the inner wall 16 may be shaped so that only the top portion of the inner wall 16 is in contact with the container 30, e.g., the inner wall 16 may be slanted, the top portion of the inner wall 16 may be curve inward or the like. Moreover, the shape of the fluid source retention area 42 may depend on various factors such as shape of container 30, size of container 30, cost, manufacturing and the like. As such, the fluid source retention area 42 may be shaped to substantially hold the container 30 in place.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A device for trapping arthropods, comprising:
a base;
a first wall coupled to the base and having an exterior surface, the base and the first wall defining a fluid source retention area;
a second wall coupled to the base and surrounding the first wall, the second wall having an interior and exterior surface; and
the exterior surface of the second wall having a first texture, and the exterior surface of the first wall and interior surface of the second wall having a second texture, the first texture being more coarse than the second texture.

2. The device of claim 1, wherein the first wall and second wall define a channel to receive a fluid.

3. The device of claim 2, further comprising a conduit coupling coupled to the first wall and disposed within the channel, the conduit coupling having a first port arranged to receive the fluid and a second port arranged to emit the fluid.

4. The device of claim 1, wherein the first texture has a surface roughness greater than 4.0 micrometers (μm) and the second texture has a surface roughness less than 3.0 μm.

5. A system for trapping arthropods, comprising:
a capture platform having:
a base;
an outer wall coupled to the base, the outer wall having an interior surface, an exterior surface and a perimeter, the exterior surface of the outer wall having a first texture and the interior surface of the outer wall having a second texture, the first texture being more course than the second texture; and
a fluid source retention area; and
a fluid source positionable within the fluid source retention area.

6. The system of claim 5, wherein the capture platform further includes an inner wall coupled to the base and disposed within the perimeter of the outer wall, the inner wall having an exterior surface with a second texture.

7. The system of claim 6, wherein the inner wall and the base define the fluid source retention area, the fluid source being removably disposed within the fluid source retention area.

8. The system of claim 6, wherein the outer wall and inner wall define a channel arranged to receive a fluid from the fluid source.

9. The system of claim 8, further comprising a fluid conduit having a distal end and proximal end opposite the distal end, the proximal end of the fluid conduit being removably coupled to the fluid source and the distal end of the fluid conduit being disposed proximate the channel.

10. The system of claim 9, further comprising a conduit coupling coupled to the inner wall and disposed within the channel, the conduit coupling having a first port arranged to receive the fluid from the fluid source and a second port arranged to emit the fluid.

11. The system of claim 10, wherein the distal end of the fluid conduit is removably couplable to the conduit coupling.

12. The system of claim 8, wherein the fluid is carbon dioxide.

13. The system of claim 6, wherein the first texture has a surface roughness greater than 4.0 micrometers (μm) and the second texture has a surface roughness less than 3.0 μm.

14. The system of claim 6, wherein an interior surface of the inner wall has the first texture.

15. The system of claim 6, wherein the fluid source includes a regulator.

16. The system of claim 6, further including diatomaceous earth, wherein at least one of a portion of the base, a portion of the inner wall and a portion of the outer wall is coatable with the diatomaceous earth.

17. The system of claim 5, wherein the outer wall has an upper tapered portion.

18. A method for trapping arthropods, comprising:
positioning a trap, the trap having:
a base, the base including:
a first wall coupled to the base and having an exterior surface, the base and the first wall defining a fluid source retention area;
a second wall coupled to the base and surrounding the first wall, the second wall having an interior and exterior surface;
the exterior surface of the second wall having a first texture, and the exterior surface of the first wall and interior surface of the second wall having a second texture, the first texture being more coarse than the second texture.

19. The method of claim 18, further comprising positioning the fluid source within the fluid source retention area.

20. The method of claim 19, further comprising:
coupling a proximal end of a fluid conduit to the fluid source; and
positioning the distal end of the fluid conduit proximate the first wall.
